(19) United States
(12) Patent Application Publication
(10) Pub. No.: US 2018/0192772 A1
(43) Pub. Date: Jul. 12, 2018

(54) STORAGE CASE

(71) Applicant: Kazunobu YAMAMOTO, Niigata-Pref. (JP)

(72) Inventor: Kazunobu YAMAMOTO, Niigata-Pref. (JP)

(21) Appl. No.: 15/693,502

(22) Filed: Sep. 1, 2017

(30) Foreign Application Priority Data
Jan. 10, 2017 (CN) 2017-002179

(51) Int. Cl. A47B 88/919; A47B 87/02; E05B 1/00

(52) U.S. Cl. CPC A47B 88/919; A47B 2088/939; E05B 1/0015; A47B 87/0276

(57) ABSTRACT

A storage case includes a main body, a drawer, a lower handle, and an upper handle. The main body is formed from a synthetic resin and includes an open front side. The drawer is freely pulled out of and pushed into the main body through the open front side. The drawer is formed from a synthetic resin. The lower handle is arranged on a lower portion of a front surface of the drawer. The upper handle is arranged on an upper portion of the front surface of the drawer.

### BACKGROUND OF THE INVENTION

The present invention relates to a storage case used in, for example, a typical household to store and organize clothing and various small items or the like.

A storage case known in the prior art includes a main body and a drawer. The main body is formed from a synthetic resin and has an open front side. The drawer can be freely pulled out of and pushed into the main body through the open front side of the main body. The drawer is formed from a synthetic resin and includes an open upper side.

### BRIEF SUMMARY OF THE INVENTION

In the prior art structure, the front lower portion of the drawer includes a handle. A user places his or her hand on the handle with the fingers directed in the upper direction to pull out the drawer. Since the handle is located on the lower portion of the front surface of the handle, the user may have to bend his or her body to pull out the drawer depending on the location or situation where the storage case is used. In such a case, it may be difficult for the user to pull out the drawer.

To solve such a problem, one aspect of the present invention provides a storage case including a main body, a drawer, a lower handle, and an upper handle. The main body is formed from a synthetic resin and includes an open front side. The drawer is freely pulled out of and pushed into the main body through the open front side. The drawer is formed from a synthetic resin. The lower handle is arranged on a lower portion of a front surface of the drawer. The upper handle is arranged on an upper portion of the front surface of the drawer.

A further aspect of the present invention provides a storage case including a frame, a top plate, a main body, a drawer, a lower handle, and an upper handle. The frame includes a bottom plate, left and right side plates, a rear plate, an open front side, and an open upper side. The frame is formed from a synthetic resin. The top plate covers the upper side of the main body. The top plate is formed from a synthetic resin. The main body includes the frame and the top plate. The drawer is freely pulled out of and pushed into the main body through the open front side of the frame in the main body. The drawer is formed from a synthetic resin and includes an open upper side. The lower handle is arranged on a lower portion of a front surface of the drawer. The upper handle is arranged on an upper portion of the front surface of the drawer.

Another aspect of the present invention provides a storage case including a plurality of frames, a top plate, a main body, a plurality of drawers, a lower handle, and an upper handle. The frames can be stacked one upon the other. Each frame includes a bottom plate, left and right side plates, a rear plate, an open front side, and an open upper side. The frames are formed from a synthetic resin. The top plate covers the upper side of an uppermost one of the stacked frames. The top plate is formed from a synthetic resin. The main body includes the frames and the top plate. The drawers are freely pulled out of and pushed into the main body through the open front sides of the frames in the main body. Each drawer is formed from a synthetic resin and includes an open upper side. The lower handle is arranged on a lower portion of a front surface of each drawer. The upper handle is arranged on an upper portion of the front surface of each drawer.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of a first embodiment according to the present invention;

FIG. 2 is a perspective view of the first embodiment according to the present invention;

FIG. 3 is an exploded perspective view showing part of the first embodiment according to the present invention;

FIG. 4 is a cross-sectional view of the first embodiment according to the present invention;

FIG. 5 is a cross-sectional view showing part of the first embodiment according to the present invention;

FIG. 6 is a front view showing the first embodiment according to the present invention;

FIG. 7 is a rear view showing part of a drawer in the first embodiment according to the present invention;

FIG. 8 is a perspective view of a second embodiment according to the present invention; and

FIG. 9 is an exploded perspective view showing part of the second embodiment according to the present invention.

### DETAILED DESCRIPTION OF THE INVENTION

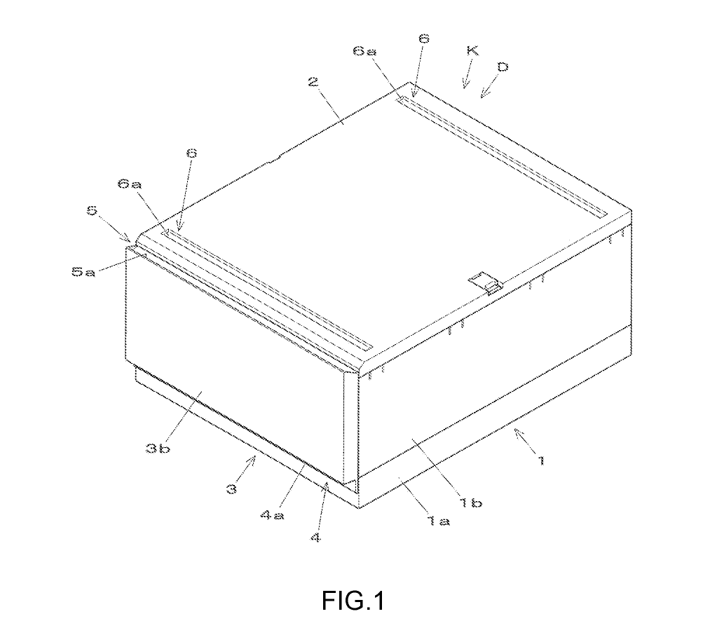

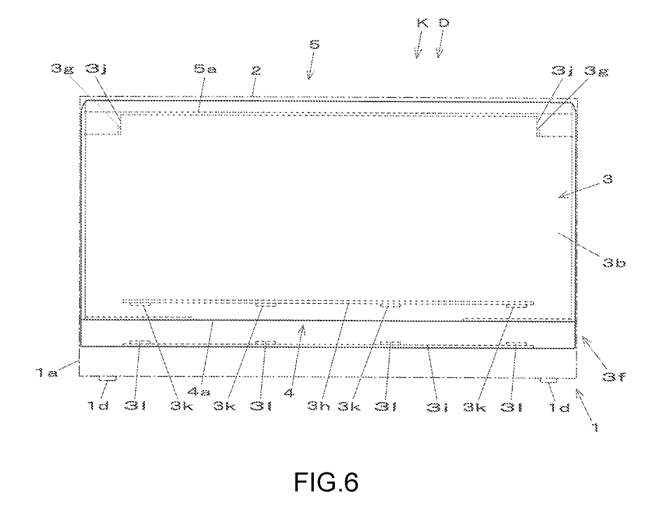

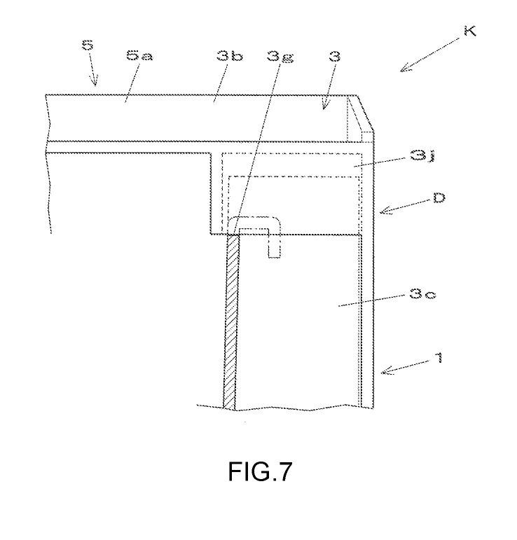

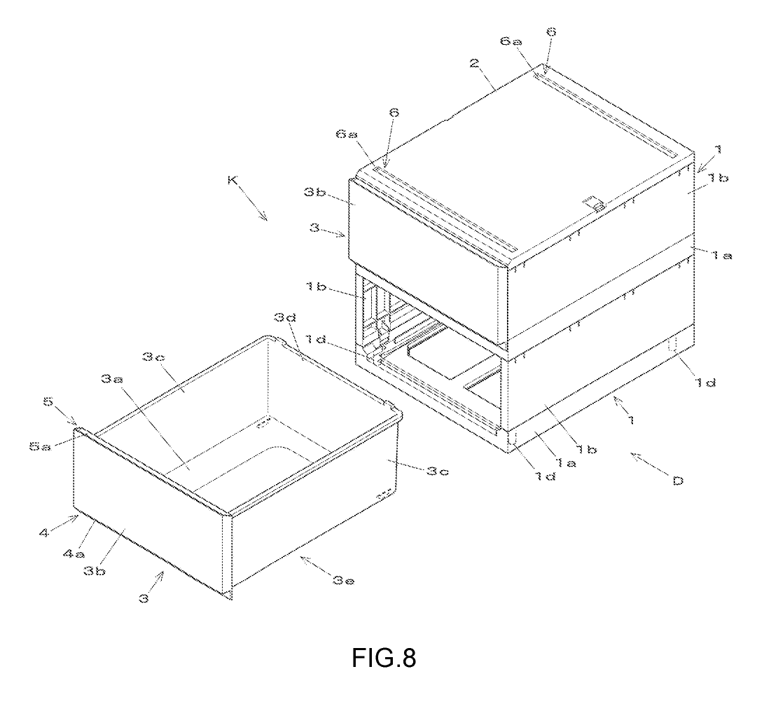

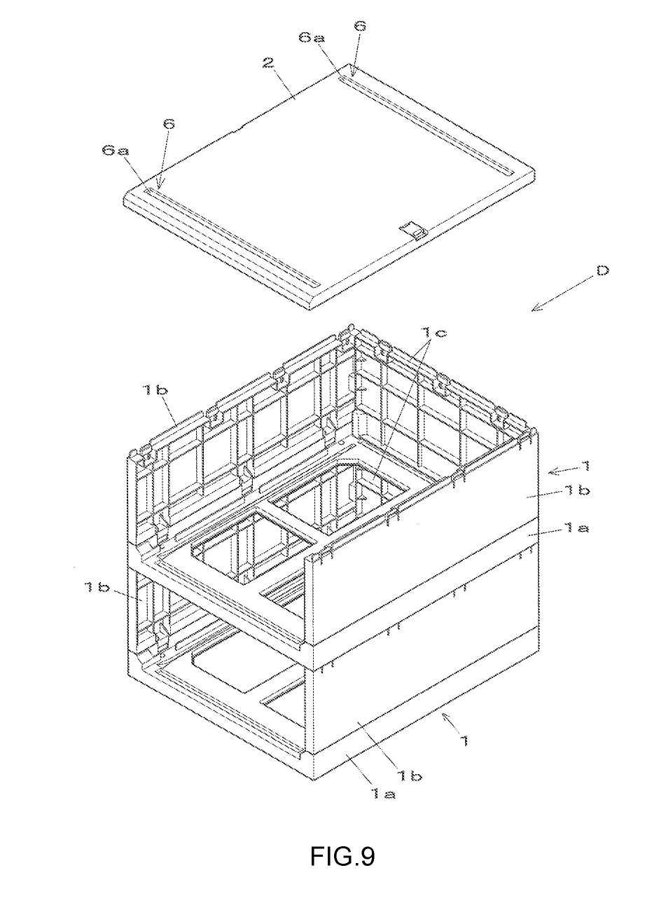

FIGS. 1 to 9 show embodiments according to the present invention. FIGS. 1 to 7 show a first embodiment, and FIGS. 8 and 9 show a second embodiment.

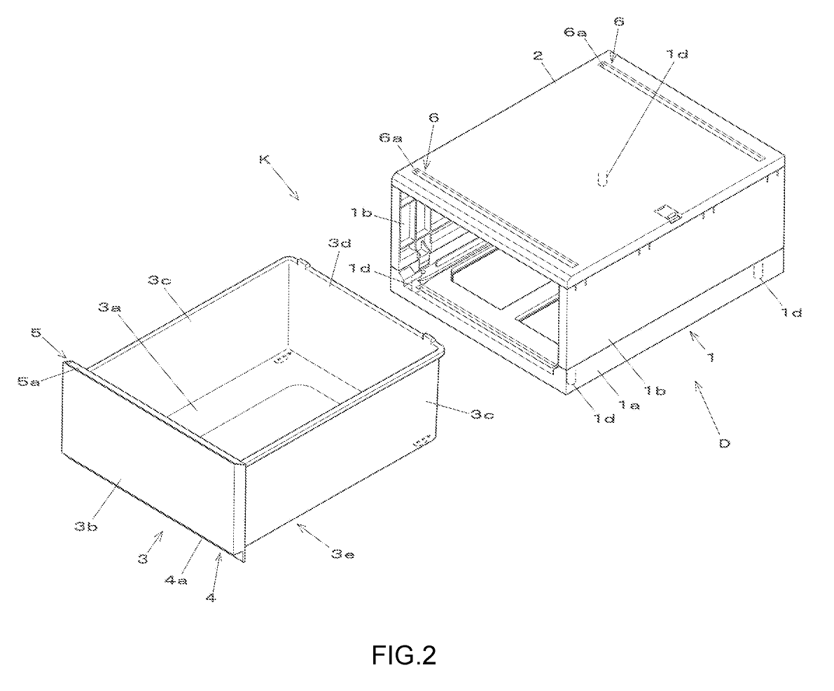

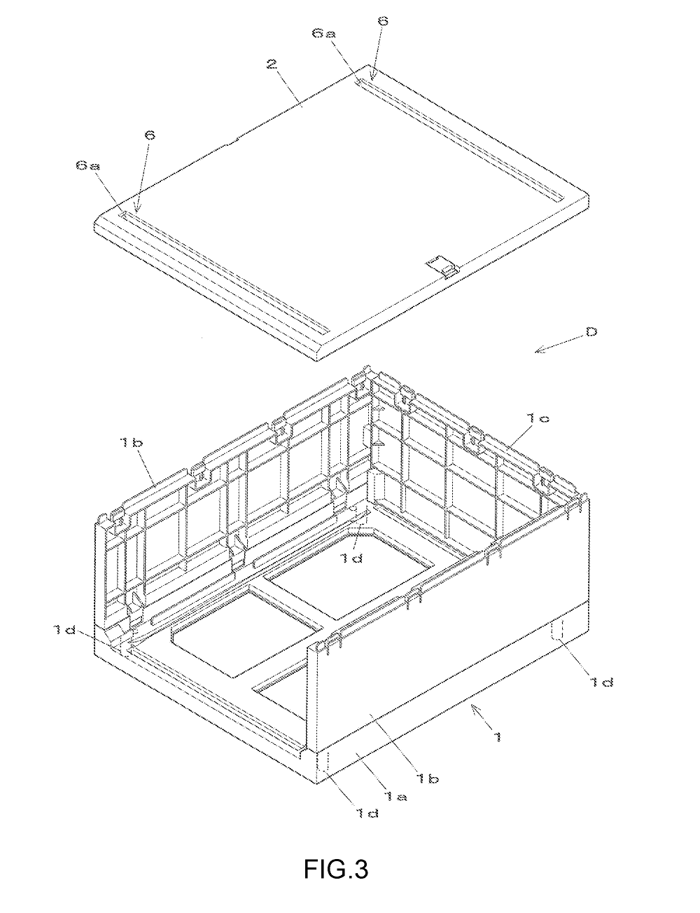

In the first embodiment of FIGS. 1 to 7, a frame 1, which is formed from a synthetic resin and shown in FIGS. 2 and 3, includes a bottom plate 1a, left and right side plates 1b, a rear plate 1c, an open front side, and an open upper side.

As shown in FIGS. 1, 2, and 3, a top plate 2, which is formed from a synthetic resin, is attached in a removable manner to the frame 1 to cover the upper side of the frame 1.

As shown in FIGS. 1, 2, and 3, a drawer 3, which is formed from a synthetic resin, includes a bottom plate 3a, a front plate 3b, left and right side plates 3c, and a rear plate 3d. In this case, the left and right side plates 3c are formed integrally with the left and right sides of the bottom plate 3a, and the rear plate 3d is formed integrally with the rear side of the bottom plate 3a. The front plate 3b is attached to the front portions of the bottom plate 3a and the left and right side plates 3c. The drawer 3 is container-like and has an open upper side. The frame 1 and the top plate 2 form a main body D. The drawer 3 can be freely pulled out of and pushed into the main body D through the open front side of the main body D. The frame 1, the top plate 2, and the drawer 3 form a storage case K.

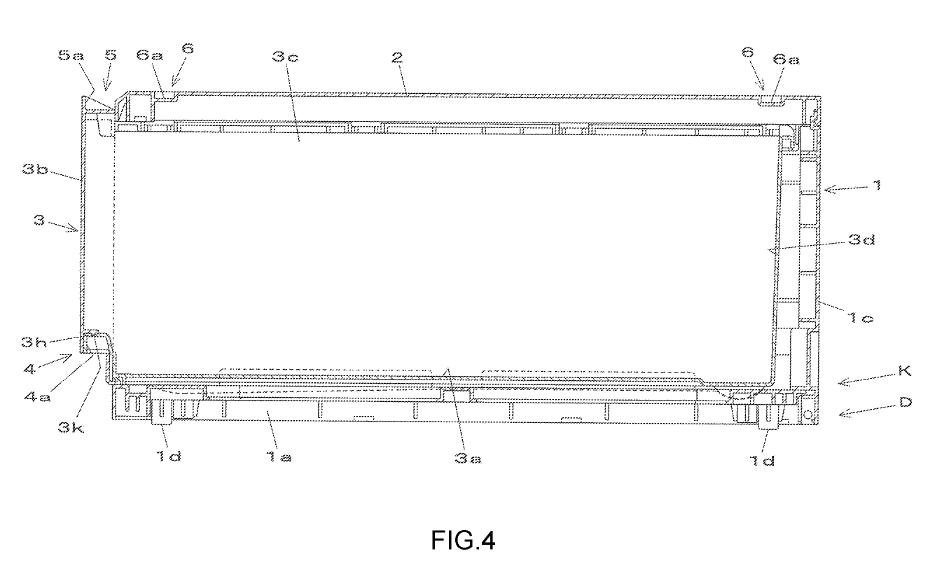

As shown in FIGS. 4, 5, 6, and 7, a lower portion of a front surface of the drawer 3 includes a lower handle 4, and an upper portion of the front surface of the drawer 3 includes an upper handle 5.

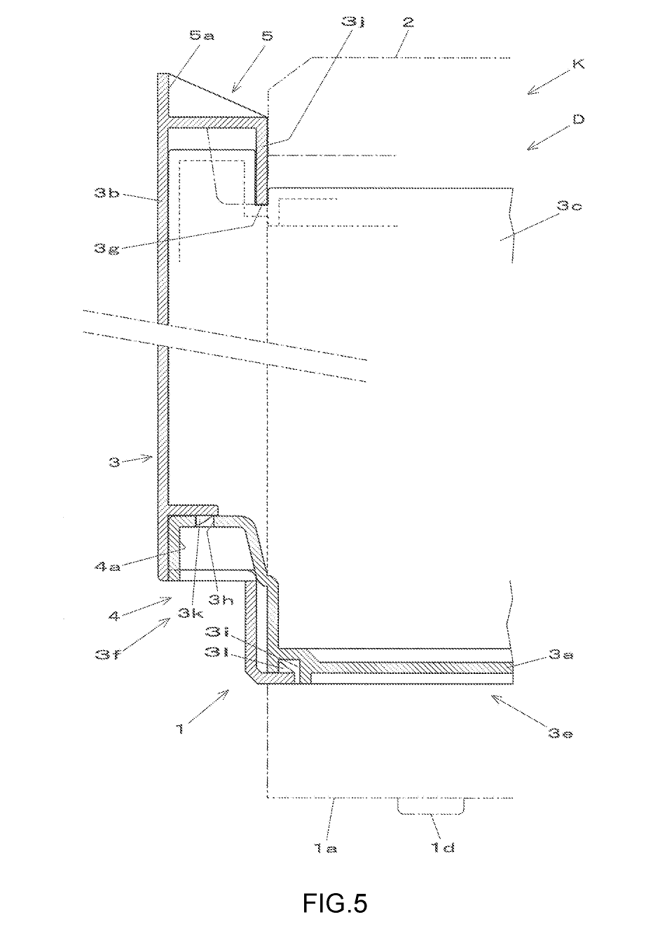

As shown in FIGS. 2, 4, 5, 6, and 7, the drawer 3 includes a drawer body 3e and the front plate 3b. The bottom plate 3a and the left and right side plate 3c are integrated to form the drawer body 3e. A coupling mechanism 3f couples the front plate 3b to the front portion of the drawer body 3e. As shown in FIGS. 5, 6, and 7, the coupling mechanism 3f includes a coupling groove 3g formed in a front upper portion of the drawer body 3e, four engagement holes 3h and four engagement grooves 3i that are formed in a front lower portion of the drawer body 3e, an engagement wall 3j formed in an upper portion of the front plate 3b to engage the coupling groove 3g, four engagement protrusions 3k formed in a lower portion of the front plate 3b to engage the engagement holes 3h, and four engagement projections 3l formed in the lower portion of the front plate 3b to engage the engagement grooves 3i. The lower handle 4 includes a catch surface 4a that is recessed in the lower portion of the drawer body 3e. The upper handle 5 includes a catch surface 5a that is recessed in the upper portion of the front plate 3b.

Referring to FIGS. 1, 2, and 3, a stable stacking mechanism 6 includes grooves 6a, which are formed in the upper surface of the top plate 2 and extend in a direction orthogonal to the moving direction of the drawer 3, and four fitting portions 1d, two in the front and two in the rear of the lower surface of the bottom plate 1a of the frame 1. The fitting portions 1d are movable in the grooves 6a of a top plate 2 of another main body D.

As described above, the first embodiment includes the main body D, which is formed from a synthetic resin and has an open front side, and the drawer 3, which is formed from a synthetic resin and has an open upper side. Further, the lower handle 4 is located on the lower portion of the front surface of the drawer 3, and the upper handle 5 is located on the upper portion of the front surface of the drawer 3. Thus, when pulling out the drawer 3, fingers, directed in an upward direction, may be inserted into the lower handle 4 on the lower portion of the front surface of the drawer 3 to hold the catch surface 4a and pull out the drawer 3. Fingers, directed in a downward direction, may also be inserted into the upper handle 5 on the upper portion of the front surface of the drawer 3 to hold the catch surface 5a and pull out the drawer 3. In this manner, there are two ways to pull out the drawer 3, one using the lower handle 4 and the other using the upper handle 5. Thus, the handle used for pulling may be selected in accordance with the height where the storage case K is arranged or the stacked number of the storage cases K. This allows the drawer 3 to be easily pulled out and improves convenience for the user.

In this case, the frame 1 includes the bottom plate 1a, the left and right side plates 1b, and the rear plate 1c. The frame 1 is formed from a synthetic resin and has an open front side and an open upper side. The top plate 2 is formed from a synthetic resin and covers the upper side of the frame 1. The main body D includes the frame 1 and the top plate 2. The drawer 3, which is formed from a synthetic resin and has an open upper side, is freely pulled out of and pushed into the main body D through the open front side of the main body D. The lower handle 4 is arranged on the lower portion of the front surface of the drawer 3. The upper handle 5 is arranged on the upper portion of the front surface of the drawer 3. When pulling out the drawer 3, fingers, directed in the upward direction, may be inserted into the lower handle 4 on the lower portion of the front surface of the drawer 3 to hold the catch surface 4a and pull out the drawer 3. Fingers, directed in the downward direction, may also be inserted into the upper handle 5 on the upper portion of the front surface of the drawer 3 to hold the catch surface 5a and pull out the drawer 3. Thus, the handle used for pulling may be selected in accordance with the height where the storage case K is arranged or the stacked number of the storage cases K. This allows the drawer 3 to be easily pulled out and improves convenience for the user.

In a state in which, for example, a plurality storage cases K are stacked, the stable stacking mechanism 6 prevents an upper storage case K from falling off from the front side of the lower storage case K by fitting the fitting portions 1d of the upper storage case K into the grooves 6a of the lower storage case K. Thus, the stable stacking mechanism 6 increases the stacking stability of the storage cases K. Further, while keeping the storages cases K stably stacked, the layout of the storage cases K can easily be changed in the widthwise direction of the storage cases K, that is, in the direction orthogonal to the moving direction of the drawer 3. This increases the freedom of layout of the storage cases K and allows the layout of the storage cases K, which can be stacked, to be changed in accordance with how the storage cases K are used, where the storage cases K are used, and the items stored in the storage cases K. Thus, the storage cases K can be used in a variety of forms and is convenient.

FIGS. 8 and 9 show a second embodiment. In this case, the main body D includes two frames 1, which are stacked one upon the other, and a top plate 2. In the same manner as the first embodiment, each frame 1 is formed from a synthetic resin and includes the bottom plate 1a, the left and right side plates 1b, the rear plate 1c, an open front side, and an upper open side. The top plate 2 covers the upper side of the uppermost one of the stacked frames 1. Two drawers 3, which are formed from a synthetic resin and are open at the upper side, are respectively arranged in the main body D through the open front sides of the frames 1 and can be freely pulled out of and pushed into the main body D. two frames 1 are stacked one upon the other. The lower portion of the front surface of each frame 1 includes the lower handle 4, which has the same structure of that in the first embodiment. The upper portion of the front surface of each frame 1 includes the upper handle 5, which has the same structure as that in the first embodiment. Thus, when pulling out each drawer 3, fingers, directed in an upward direction, may be inserted into the lower handle 4 on the lower portion of the front surface of the drawer 3 to hold the catch surface 4a and pull out the drawer 3. Fingers, directed in a downward direction, may also be inserted into the upper handle 5 on the upper portion of the front surface of each drawer 3 to hold the catch surface 5a and pull out the drawer 3. Thus, the handle used for pulling may be selected in accordance with the height where the storage case K is arranged or the stacked number of the storage cases K. This allows the drawer 3 to be easily pulled out and improves convenience for the user.

The present invention is not limited to the upper embodiment. For example, the number of the frames 1, the stacked number of the frames 1, the size of the frames 1, the shape of the top plate 2, the number of the drawers 3, and the structure may be changed in accordance with the application.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

What is claimed is:

1. A storage case comprising:
a main body formed from a synthetic resin and including an open front side;
a drawer that is freely pulled out of and pushed into the main body through the open front side, wherein the drawer is formed from a synthetic resin;
a lower handle arranged on a lower portion of a front surface of the drawer; and
an upper handle arranged on an upper portion of the front surface of the drawer.

2. A storage case comprising:
a frame including a bottom plate, left and right side plates, a rear plate, an open front side, and an open upper side, wherein the frame is formed from a synthetic resin;
a top plate that covers the upper side of the main body, wherein the top plate is formed from a synthetic resin;
a main body including the frame and the top plate;
a drawer that is freely pulled out of and pushed into the main body through the open front side of the frame in the main body, wherein the drawer is formed from a synthetic resin and includes an open upper side;
a lower handle arranged on a lower portion of a front surface of the drawer; and
an upper handle arranged on an upper portion of the front surface of the drawer.

3. A storage case comprising:
a plurality of frames that can be stacked one upon the other, each frame including a bottom plate, left and right side plates, a rear plate, an open front side, and an open upper side, wherein the frames are formed from a synthetic resin;
a top plate that covers the upper side of an uppermost one of the stacked frames, wherein the top plate is formed from a synthetic resin;
a main body including the frames and the top plate;
a plurality of drawers that are freely pulled out of and pushed into the main body through the open front sides of the frames in the main body, wherein each drawer is formed from a synthetic resin and includes an open upper side;
a lower handle arranged on a lower portion of a front surface of each drawer; and
an upper handle arranged on an upper portion of the front surface of each drawer.
